(19) United States
(12) Patent Application Publication
(10) Pub. No.: US 2010/0109841 A1
(43) Pub. Date: May 6, 2010

(54) READER AND MANAGEMENT SYSTEM

(75) Inventors: Akiko YAMADA, Yokohama-Shi (JP); Hiroki Shoki, Kawasaki-Shi (JP); Shuichi Obayashi, Yokohama-Shi (JP); Kazuhiro Inoue, Tokyo (JP); Makoto Higaki, Kawasaki-Shi (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: Kabushiki Kaisha Toshiba, Tokyo (JP)

(21) Appl. No.: 12/485,377

(22) Filed: Jun. 16, 2009

(30) Foreign Application Priority Data
Nov. 5, 2008 (JP) 2008-284108

(51) Int. Cl. H04Q 5/22

(52) U.S. Cl. 340/10.1

(57) ABSTRACT

A reader that performs wireless communication with a tag inside a metal housing including a plurality of metal walls, the reader has an antenna which transmits and receives electromagnetic wave, a transmission control device that writes and/or reads information to/from the tag via the antenna, and a reflecting plate, reflecting the electromagnetic wave, and having a reflection phase different from that of the metal wall.

### CROSS REFERENCE TO RELATED APPLICATION

This application is based upon and claims benefit of priority from the Japanese Patent Application No. 2008-284108, filed on Nov. 5, 2008, the entire contents of which are incorporated herein by reference.

### BACKGROUND OF THE INVENTION

The present invention relates to a reader and a management system.

In various fields, RFID (Radio Frequency Identification) systems have been introduced which perform non-contact data transmission using radio transmission between an RFID tag with IC chip and a reader. The RFID tags include an active tag and passive tag. The active tag is provided with a battery, and the IC is driven by electric power from the battery. Further, there is also an active tag which includes a transmission unit. Meanwhile, the passive tag is not provided with a battery, and the IC is driven by receiving electric power from a reader; electromagnetic wave transmitted from the reader is reflected by the tag using a technique called Back Scatter, whereby transmission is performed.

Recently, article management systems have been studied which use a UHF-band or microwave-band RFID having longer transmission distance than an electromagnetic induction type HF-band RFID. In the article management systems, in order to limit the transmission area, it is assumed that a reader antenna and RFID tag communicates in the inner side of metal shelves or boxes.

Inside metal shelves or boxes, however, there are some cases where reading cannot be performed due to the position of tag. For example, when the tag is placed close to the metal wall, since electromagnetic wave cannot propagate through the metal, current is induced on the metal wall so that incident electric field is cancelled, and thus tangential components of the electric field become zero. Consequently, of the electromagnetic wave radiated from the reader, the electric field of a component parallel to the metal wall is cancelled in the vicinity of the metal wall, so it is difficult to read the tag placed close to the metal wall.

Further, the interference of the electromagnetic wave radiated from the reader with reflected electromagnetic wave from the metal wall produces standing wave, and the intensity of electric field lowers at the position of nodes of the standing wave, so it is difficult to read the tag. Particularly, for a passive tag not including a power source, it is also difficult to get a drive power source for the tag.

Thus, a radio transmission system has been proposed in which a reflecting plate is arranged facing the antenna wherein the plate makes the polarization plane of reflected electromagnetic wave different from that of incident electromagnetic wave from the antenna, and the reflecting plate reflects the electromagnetic wave transmitted from the antenna over the wireless IC tag, so that standing wave is suppressed (for example, refer to JP-A 2007-116451 (KOKAI)).

However, according to the related art radio transmission system, while standing wave can be suppressed, the performance in reading the tag placed close to the metal wall cannot sufficiently be improved.

### SUMMARY OF THE INVENTION

According to one aspect of the present invention, there is provided a reader that performs wireless communication with a tag inside a metal housing including a plurality of metal walls, the reader comprising:

an antenna which transmits and receives electromagnetic wave;

a transmission control device that writes and/or reads information to/from the tag via the antenna; and

a reflecting plate, reflecting the electromagnetic wave, and having a reflection phase different from that of the metal wall.

According to one aspect of the present invention, there is provided a management system comprising:

a metal housing including a plurality of metal walls capable of containing an article with a tag attached thereto;

an antenna which transmits and receives electromagnetic wave;

a transmission control device that writes and/or reads information to/from the tag via the antenna; and

a reflecting plate, arranged on at least one of the metal walls inside the metal housing, reflecting the electromagnetic wave, and having a reflection phase different from that of the metal wall.

### BRIEF DESCRIPTION OF THE DRAWINGS

FIGS. 1A and 1B are schematic configuration diagrams of a management system according to a first embodiment of the present invention;

FIG. 2 is a view for describing space coordinates of opposite metal walls of a metal housing according to the first embodiment;

FIGS. 3A to 3C are electric field intensity distribution diagrams of the metal housing according to the first embodiment;

FIG. 4 is a top view of a reflecting plate according to the first embodiment;

FIG. 5A is a cross-sectional view of the reflecting plate according to the first embodiment;

FIG. 5B is a schematic view of the cross-section of the reflecting plate according to the first embodiment;

FIG. 6 is a graph illustrating reflection phase characteristics of the reflecting plate according to the first embodiment;

FIG. 7 is a top view of a reflecting plate according to a variation;

FIG. 8 is a cross-sectional view of the reflecting plate according to a variation;

FIG. 9 is a schematic configuration diagram of a management system according to a comparative example;

FIGS. 10A to 10C are electric field intensity distribution diagrams of the metal housing according to the comparative example;

FIG. 11 is a schematic configuration diagram of a management system according to a variation;

FIG. 12 is a view illustrating an example of arranging a reflecting plate;

FIG. 13 is a view illustrating an example of arranging a reflecting plate;

FIG. 14 is a schematic configuration diagram of a management system according to a second embodiment of the present invention; and

FIG. 15 is a schematic configuration diagram of a management system according to a third embodiment of the present invention.

### DESCRIPTION OF THE EMBODIMENTS

Embodiments of the present invention will be described below with reference to the drawings.

### First embodiment

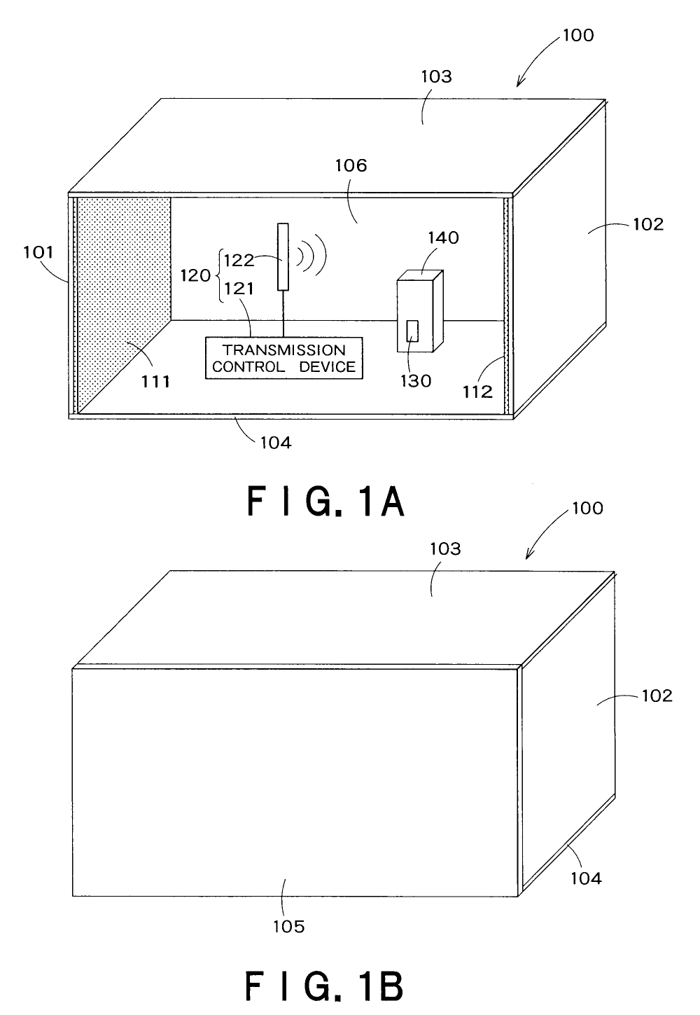

FIG. 1A schematically illustrates a configuration of a management system according to a first embodiment of the present invention. The management system includes a metal housing 100 and a read device (reader). The read device includes reflecting plates 111 and 112 and a tag reader 120. The metal housing 100 is composed of six metal walls 101 to 106. Here, for illustrative purposes, the metal wall 105 positioned in the front side in FIG. 1A is not illustrated so that the inner side of the metal housing 100 can be seen; but actually the six sides of the metal housing are, as illustrated in FIG. 1B, covered with the metal walls 101 to 106.

The metal housing 100 contains an article 140 with a tag 130 attached thereto. Written in the tag 130 is identification data (ID) unique to the tag, information on the article 140, and other types of information. The tag 130 is either an active tag or passive tag.

Inside the metal housing 100, the reflecting plates 111 and 112 are arranged on the metal walls 101 and 102 facing each other. The reflecting plates 111 and 112 have a reflection phase different from the metal, implementing magnetic wall characteristics. The structure of the reflecting plates 111 and 112 will be described later.

The tag reader 120 includes a transmission control device 121 and antenna 122. Inside the metal housing 100, the transmission control device 121 transmits electromagnetic wave via the antenna 122 to the tag 130, and also reads or writes information from/to the tag 130. The frequency band of electromagnetic wave transmitted/received via the antenna is the UHF band or microwave band, for example. The UHF band and microwave band have longer transmission distance, but when a metal housing is used, the transmission area can be limited.

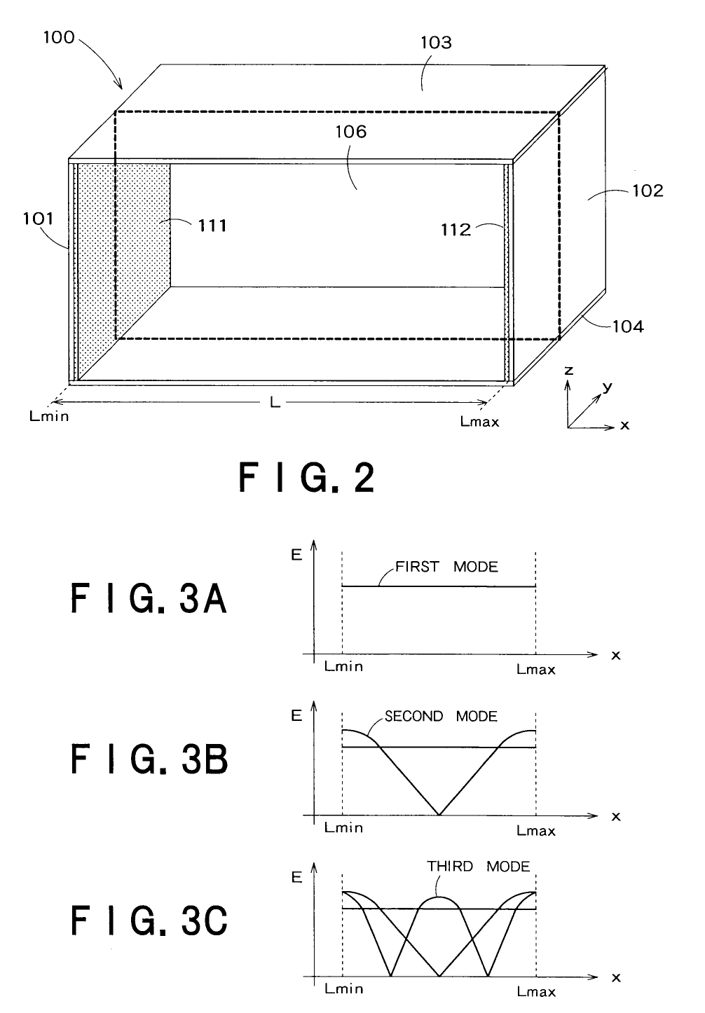

There will be described the electric field produced inside the metal housing 100 when electromagnetic wave is transmitted via the antenna 122. As illustrated in FIG. 2, x-axis, y-axis and z-axis are set. More specifically, the metal walls 101 and 102 are parallel to the y-z plane; the metal walls 103 and 104 are parallel to the x-z plane; and the metal walls 105 and 106 are parallel to the x-y plane. Further, assume that the distance between the metal wall 101 and metal wall 102 is L, the x-axis coordinate of the metal wall 101 is Lmin, and the x-axis coordinate of the metal wall 102 is Lmax. The electric field on a plane parallel to the x-z plane indicated by the dotted line in FIG. 2 will be described. Here, for simplicity, assume that the positions of the reflecting plates 111 and 112 are equal to those of the metal walls 101 and 102 and that the reflection phase is 0°.

FIG. 3 illustrates the distribution of electric field intensity E which appears inside the metal housing 100. Here, the first to third modes are considered.

FIG. 3A illustrates a case in which distance L satisfies Formula 1 and only the basic (first) mode exists.

$$\frac{{c}^{( 1 )}}{{f}_{c}} < L < \frac{{c}^{( 2 )}}{{f}_{c}} \qquad [ Formula 1 ]$$

where “f_{c}” is cut off frequency and “c” is the velocity of light. Therefore, c/f_{c} is free space wave length (cut off wave length) corresponding to cut off frequency. Formula 2 expresses the cut off wave length in the basic mode.

$$\frac{{c}^{( 1 )}}{{f}_{c}} \qquad [ Formula 2 ]$$

Formula 3 expresses the cut off wave length in the second mode.

$$\frac{{c}^{( 2 )}}{{f}_{c}} \qquad [ Formula 3 ]$$

FIG. 3B illustrates a case in which distance “L” satisfies Formula 4 and the basic and second modes exist.

$$\frac{{c}^{( 2 )}}{{f}_{c}} < L < \frac{{c}^{( 3 )}}{{f}_{c}} \qquad [ Formula 4 ]$$

Formula 5 expresses the cut off wave length in the third mode.

$$\frac{{c}^{( 3 )}}{{f}_{c}} \qquad [ Formula 5 ]$$

In this case, the electric field is composed of a combination of the basic mode and the second mode.

FIG. 3C illustrates a case in which distance “L” satisfies Formula 6 and the first to third modes exist. The electric field is composed of a combination of the basic mode, second mode and third mode.

$$\frac{{c}^{( 3 )}}{{f}_{c}} < L \qquad [ Formula 6 ]$$

As evident from FIGS. 3A to 3C, since the reflection phase of the reflecting plates 111 and 112 is zero, there occurs no cancellation of electric field at Lmin and Lmax (the positions of the metal walls 101 and 102) and thus the electric field intensity does not decrease.

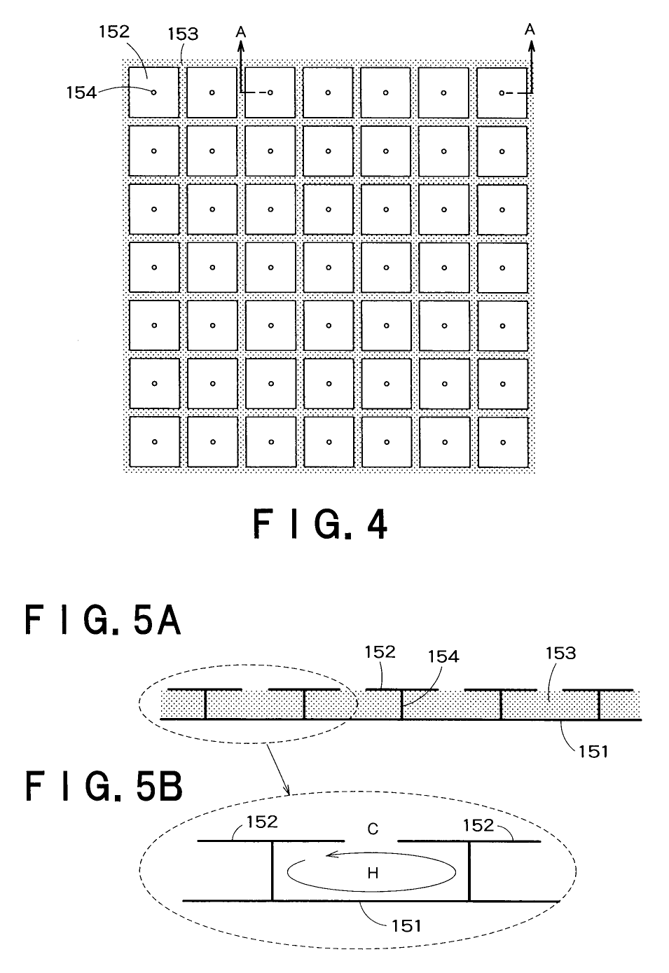

The structure of the reflecting plate 111 (112) implementing the magnetic wall characteristics will be described. FIG. 4 illustrates a top view of the reflecting plate 111; and FIG. 5A illustrates a sectional view of the reflecting plates 111 along the line A-A in FIG. 4.

The reflecting plate 111 includes a ground plane 151, metal patch 152 arranged in a matrix shape on the ground plane 151, dielectric material 153 arranged between the ground plane 151 and metal patch 152, and via 154, arranged substantially at the center of the metal patch 152, and penetrating through the dielectric material 153. The metal patch 152 is made of copper, for example. The dielectric material 153 is made of Teflon, for example.

FIG. 5B is a schematic view partially illustrating the cross-section of the reflecting plate 111 illustrated in FIG. 5A. As shown in FIG. 5B, high frequency current readily accumulates electric charge in a section where the adjoining metal patches 152 are close to each other, and this section can be considered an equivalent circuit of capacitor C.

In a path that extends along the ground plane 151 facing the capacitor C, the change of phase occurs, and the path can be considered an equivalent circuit of inductance H.

Consequently, the reflecting plate 111 constitutes an LC (inductance-capacitance) resonator, and there exists a frequency band in which antiresonance occurs in a direction parallel to the ground plane 151. In such frequency band, the impedance becomes significantly large, so the occurrence of high frequency current is suppressed and the reflection phase is close to 00.

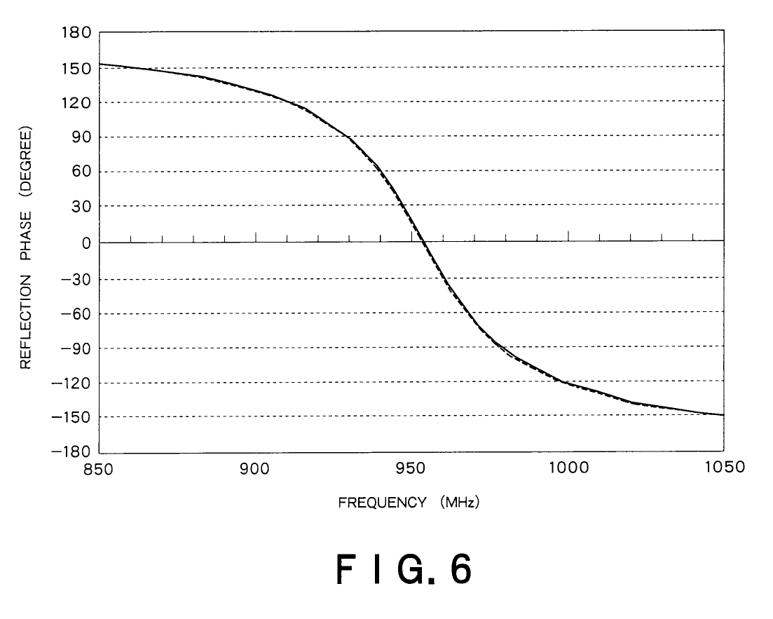

FIG. 6 illustrates a result of simulating reflection phase characteristics on a mushroom surface when plane wave is vertically incident on an infinite periodic structure under a periodic boundary condition obtained by modeling an one-period structure of the periodic structure of the reflecting plate 111. Here, the size (width) of the metal patch 152 is 36 mm, the gap between the metal patches is 2.0 mm, the permittivity of the dielectric material 153 is 10, the thickness of the dielectric material 153 is 5.0 mm, and the radius of the via is 0.25 mm.

The solid line in FIG. 6 represents the reflection phase characteristics of the reflecting plate 111 having the structure illustrated in FIGS. 4 and 5. As evident from FIG. 6, the reflecting plate 111 has a reflection phase of 0°, that is, AMC (Artificial Magnetic Conductor) characteristics.

The reflection phase characteristics can be implemented at any frequency by setting the metal patch size, the gap between adjoining metal patches, the permittivity and thickness of the dielectric material 153, and the like. Consequently, the AMC characteristics can be implemented substantially at the operating frequency.

When the reflection phase is 00, the reflecting plate 111 works as a perfect magnetic wall. However, in a range where −90°≦θ≦90°, substantially in-phase reflection occurs, so the cancellation of electric fields is suppressed in the vicinity of the metal wall 101 provided with the reflecting plate 111. Consequently, the reflecting plate 111 is preferably designed so that the reflection phase falls into the range of +90° at the operating frequency.

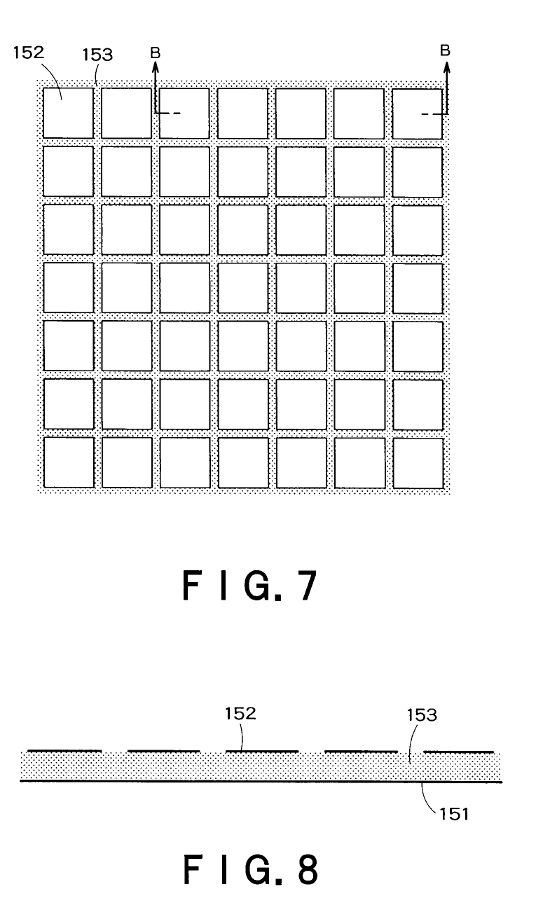

The broken line in FIG. 6 represents a result of simulating the reflection phase characteristics when the reflecting plate 111 does not have the via 154 as illustrated in FIGS. 7 and 8. FIG. 8 is a cross-sectional view of the reflecting plate 111 along the line B-B illustrated in FIG. 7. As evident from FIG. 6, substantially the same reflection phase characteristics are provided regardless of the presence or absence of the via. Consequently, the reflecting plate 111 may not have the via 154.

The reflecting plates 111 and 112 having the above structure are arranged on the opposite metal walls 101 and 102 inside the metal housing 100. Consequently, the NULL positions of electric field intensity in each mode are, as illustrated in FIG. 3, different. Thus, sufficient electric field intensity is provided regardless of whether or not the tag 130 is close to the metal walls 101 and 102 in the metal housing 100, so that the information of the tag 130 can be read.

### COMPARATIVE EXAMPLE

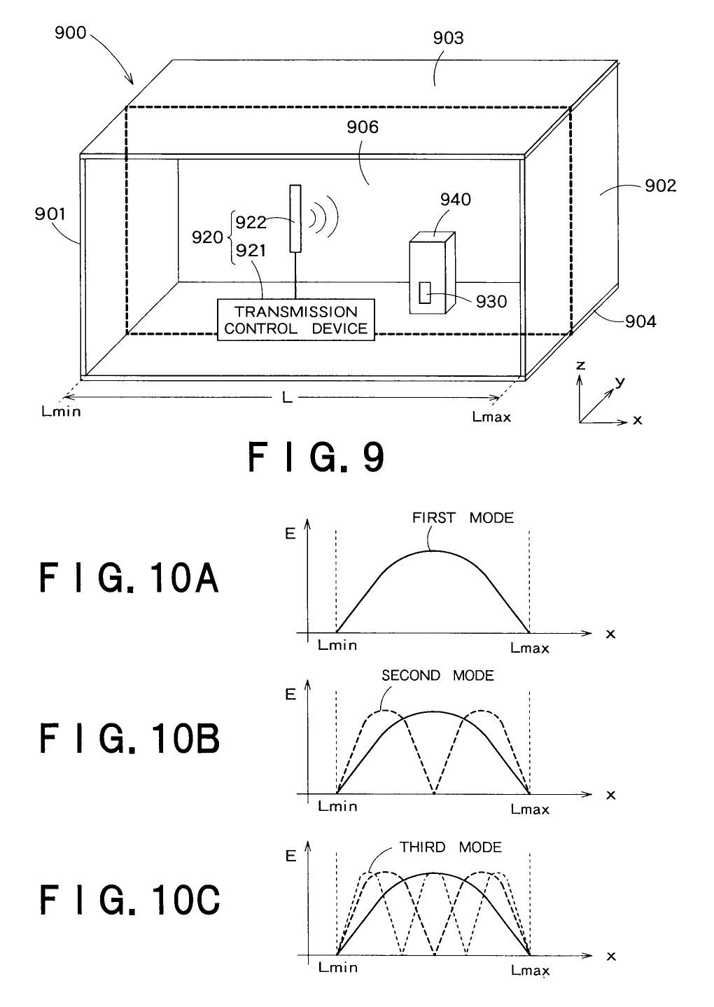

FIG. 9 schematically illustrates a configuration of a management system according to a comparative example. The management system includes a metal housing 900 and tag reader 920. The metal housing 900 is composed of six metal walls 901 to 906. The metal housing 900 contains an article 940 with a tag 930 attached thereto. Differently from the first embodiment, the reflecting plate 111 is not provided on the metal wall. Similarly to FIG. 1A, the metal wall 905 positioned in the front side in FIG. 9 is not illustrated.

The tag reader 920 includes a transmission control device 921 and antenna 922. Inside the metal housing 900, the transmission control device 921 transmits electromagnetic wave via the antenna 922 to the tag 930, and reads information from the tag 930.

There will be described the electric field produced inside the metal housing 900 when electromagnetic wave is transmitted via the antenna 922. As illustrated in FIG. 9, x-axis, y-axis and z-axis are set. More specifically, the metal walls 901 and 902 are parallel to the y-z plane; the metal walls 903 and 904 are parallel to the x-z plane; and the metal walls 905 and 906 are parallel to the x-y plane.

Similarly to the first embodiment, assume that the distance between the metal wall 901 and metal wall 902 is L, the x-axis coordinate of the metal wall 901 is Lmin, and the x-axis coordinate of the metal wall 902 is Lmax. The electric field on a plane parallel to the x-z plane indicated by the dotted line in FIG. 9 will be described.

FIG. 10 illustrates the distribution of electric field intensity E which appears inside the metal housing 900. Here, the first to third modes are considered. FIG. 10A illustrates a case in which distance “L” satisfies Formula 7 and only the basic (first) mode exists.

$$\frac{{c}^{( 1 )}}{{f}_{c}} < L < \frac{{c}^{( 2 )}}{{f}_{c}} \qquad [ Formula 7 ]$$

FIG. 10B illustrates a case in which distance “L” satisfies Formula 8 and the basic and second modes exist.

$$\frac{{c}^{( 2 )}}{{f}_{c}} < L < \frac{{c}^{( 3 )}}{{f}_{c}} \qquad [ Formula 8 ]$$

In this case, the electric field is composed of a combination of the basic mode and the second mode. FIG. 10C illustrates a case in which distance L satisfies Formula 9 and the first to third modes exist. The electric field is composed of a combination of the basic mode, second mode and third mode.

$$\frac{{c}^{( 3 )}}{{f}_{c}} < L \qquad [ Formula 9 ]$$

As evident from FIGS. 10A to 10C, the electric field at Lmin and Lmax (the position of the metal walls 901 and 902) is zero in any of the modes. The reason for this is that the reflection phase is 180° on the metal wall, so there occurs cancellation of electric field in the vicinity of the metal wall. Thus, when the electric field of the tag antenna is parallel to the metal wall and the tag is disposed close to the metal wall, the tag reader 920 cannot communicate with the tag 930.

According to the first embodiment, however, the reflecting plate (having a reflection phase different from the metal wall) implementing magnetic wall characteristics is provided on the metal wall of the metal housing. As a result, the cancellation of electric field in the vicinity of the metal wall is suppressed, so the tag reader can communicate with the tag which is disposed in the vicinity of the metal wall.

The structure of the reflecting plate 111 is not limited to those of FIGS. 4 and 7 as long as the magnetic wall characteristics are implemented. For example, a magnetic material having a permeability greater than 1 can be used.

According to the first embodiment, the reflecting plates are arranged on the metal walls 101 and 102. However, the reflecting plates may be arranged on any of the metal walls 101 to 106 depending on the orientation of the tag when the article is contained in the metal housing.

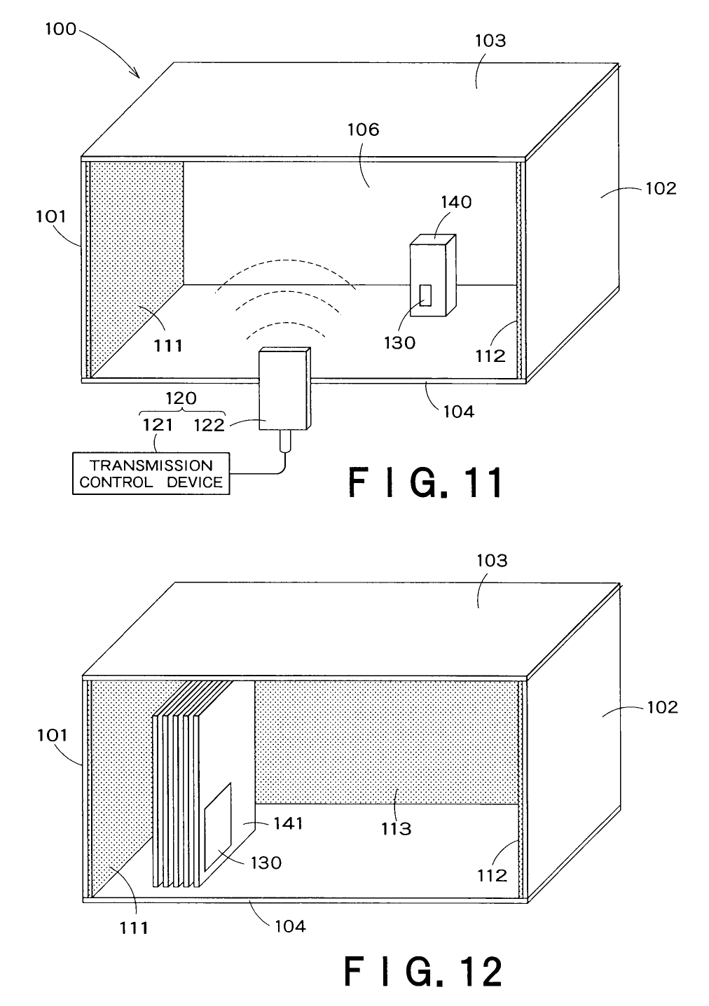

According to the first embodiment, the metal housing 100 is composed of the six metal walls 101 to 106. However, as illustrated in FIG. 11, one metal wall, for example, the metal wall 105 may not be provided; in this case, a structure with one surface opened is formed.

With this structure, using electromagnetic wave radiated from the antenna 122 disposed outside the metal housing 100, the information of the tag 130 attached to the article 140 contained in the metal housing 100 can be read.

Referring to FIG. 11, the reflecting plates 111 and 112 are arranged on the metal walls 101 and 102. However, for example, when the metal housing 100 contains, as illustrated in FIG. 12, documents (or books) 141 placed side-by-side having attached thereto the tag 130 and the electric field of the tag 130 is parallel to the z-axis, the read device preferably further includes a reflecting plate 113 and the reflecting plate 113 is arranged on the metal wall 106.

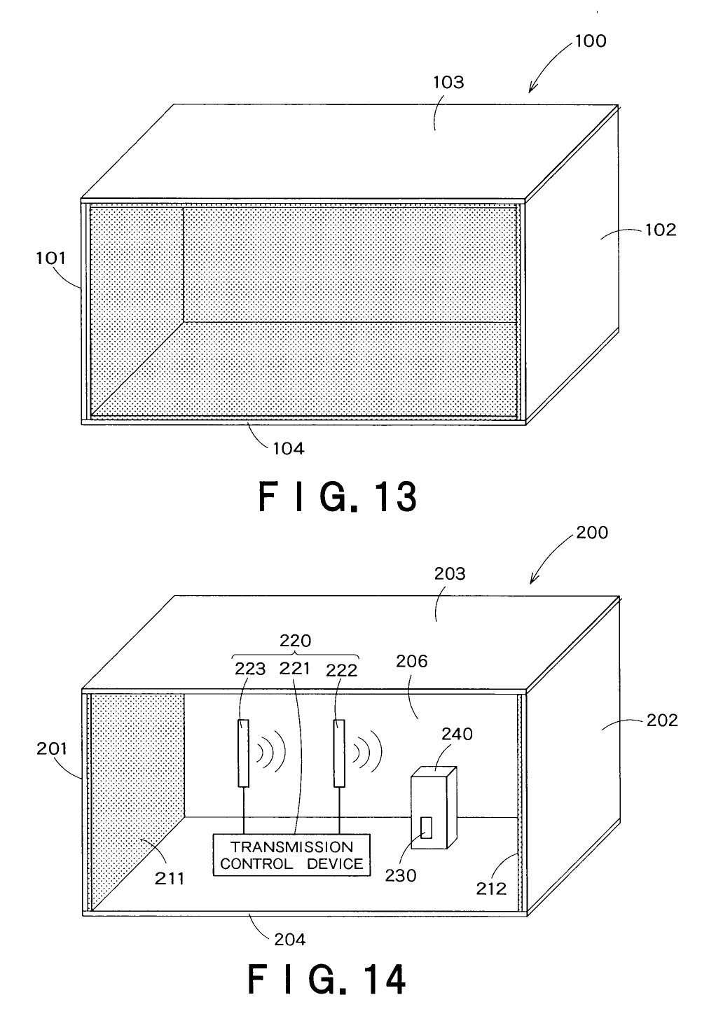

Further, when the orientation of the tag on containing the article can be substantially limited, the surface (metal wall) on which the reflecting plate is arranged can be limited to one parallel to the electric field of the tag. However, when the orientation of the tag is randomly set inside the metal housing, the reflecting plates are, as illustrated in FIG. 13, preferably provided on all the surfaces. That is, the read device includes the reflecting plates corresponding to all the surfaces of the metal housing.

### Second Embodiment

FIG. 14 schematically illustrates a configuration of a management system according to a second embodiment of the present invention. The management system includes a metal housing 200 and a read device. The read device includes reflecting plates 211 and 212 and a tag reader 220. The metal housing 200 is composed of six metal walls 201 to 206. Here, similarly to FIG. 1A, the metal wall 205 positioned in the front side in FIG. 14 is not illustrated.

The metal housing 200 contains an article 240 with a tag 230 attached thereto. Written in the tag 230 is identification data (ID) unique to the tag, information on the article 240, and other types of information. The tag 230 is either an active tag or passive tag.

Inside the metal housing 200, the reflecting plates 211 and 212 are arranged on the metal walls 201 and 202 facing each other. The reflecting plates 211 and 212 have a structure similar to the reflecting plates 111 and 112 according to the first embodiment, and an explanation thereof is omitted.

The tag reader 220 includes a transmission control device 221 and antennas 222 and 223 arranged at different positions. Inside the metal housing 200, the transmission control device 221 transmits electromagnetic wave via the antennas 222 and 223 to the tag 230 and reads the information. In this case, the transmission control device 221 performs diversity reception. More specifically, one of the antennas 222 and 223, having better reception condition, is selected to receive data transmitted from the tag 230.

In this way, two antennas are arranged at different positions, allowing more efficient communication with the tag.

The number of antennas is not limited to two, but may be three or more. Further, the reflecting plates may be provided not only on a pair of the opposite metal walls 211 and 212 but also on another metal wall. Further, the transmission control device 221 may be arranged inside the metal housing 200 or outside the metal housing 200. Further, when two or more modes occurs in the electric field between the reflecting plates facing each other inside the metal housing, the antennas may be disposed at positions where NULL appears in the respective modes.

### Third Embodiment

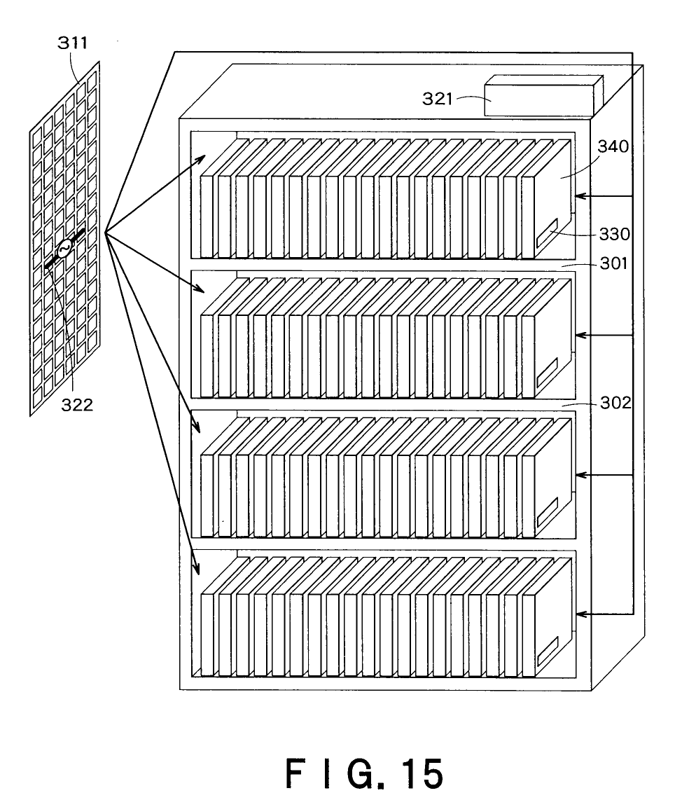

FIG. 15 schematically illustrates a configuration of a management system according to a third embodiment of the present invention. The management system is composed of metal shelves having multiple stages of containers and includes multiple shelf plates 301, 302, . . . , reflecting plates 311 arranged on side walls of each stage, transmission control device 321 provided on the upper portion of the shelf and read devices with antennas 322 disposed on each reflecting plate 311. Contained in the containers of each stage are articles (for example, documents) 340 having attached thereto a tag 330. The transmission control device 321 is connected to the antennas 322 of each stage.

The reflecting plate 311 is similar to the reflecting plate 111 of the first embodiment. Similarly to the second embodiment, diversity reception is performed between the transmission control device 321 and the antennas 322 in each shelf stage.

Since the reflecting plate 311 is arranged on the side wall, the cancellation of electric field is suppressed in the vicinity of the side wall. Consequently, the information of the tag disposed close to the side wall can be read. Further, the antennas are provided on both side walls in respective stages to perform diversity reception, allowing more efficient communication with the tags.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A reader that performs wireless communication with a tag inside a metal housing including a plurality of metal walls, the reader comprising:
an antenna which transmits and receives electromagnetic wave;
a transmission control device that writes and/or reads information to/from the tag via the antenna; and
a reflecting plate, reflecting the electromagnetic wave, and having a reflection phase different from that of the metal wall.

2. The reader according to claim 1, further comprising a plurality of the reflecting plates.

3. The reader according to claim 1,
wherein the reflecting plate comprises:
a ground plane;
a dielectric material arranged on the ground plane; and
a plurality of metal plates arranged in a matrix shape on the dielectric material.

4. The reader according to claim 3,
wherein the reflecting plate further comprises a via formed between the metal plate and the ground plane.

5. The reader according to claim 1,
wherein the reflecting plate is formed of a magnetic material.

6. The reader according to claim 1, further comprising a plurality of the antennas, wherein the transmission control device performs diversity reception.

7. The reader according to claim 1,
wherein the frequency band of electromagnetic wave transmitted/received via the antenna is the UHF band or microwave band.

8. The reader according to claim 1,
wherein the reflection phase of the reflecting plate falls into a range from minus 90 degrees to plus 90 degrees.

9. A management system comprising:
a metal housing including a plurality of metal walls capable of containing an article with a tag attached thereto;
an antenna which transmits and receives electromagnetic wave;
a transmission control device that writes and/or reads information to/from the tag via the antenna; and
a reflecting plate, arranged on at least one of the metal walls inside the metal housing, reflecting the electromagnetic wave, and having a reflection phase different from that of the metal wall.

10. The management system according to claim 9,
wherein the reflecting plate comprises:
a ground plane;
a dielectric material arranged on the ground plane; and
a plurality of metal plates arranged in a matrix shape on the dielectric material.

11. The management system according to claim 10,
wherein the reflecting plate further comprises a via formed between the metal plate and the ground plane.

12. The management system according to claim 9,
wherein the reflecting plate is formed of a magnetic material.

13. The management system according to claim 9, comprising a plurality of the antennas, wherein the transmission control device performs diversity reception.

14. The management system according to claim 9,
wherein at least two of the plurality of metal walls face each other, and the reflecting plates are arranged on each of the two opposite metal walls.

15. The management system according to claim 9,
wherein: the metal housing includes five metal walls and has a hexahedral structure with one surface opened; a first metal wall faces a second metal wall; a third metal wall faces a fourth metal wall; a surface facing a fifth metal wall is opened; and the reflecting plates are arranged on the first metal wall and the second metal wall.

16. The management system according to claim 15,
wherein the reflecting plate is arranged on the fifth metal wall.

17. The management system according to claim 16,
wherein the reflecting plates are arranged on the third metal wall and the fourth metal wall.

18. The management system according to claim 15,
wherein: two of the antennas are provided; a first antenna is arranged on the reflecting plate on the first metal wall; a second antenna is arranged on the reflecting plate on the second metal wall; and the transmission control device performs diversity reception.

19. The management system according to claim 9,
wherein: the metal housing includes six metal walls and has a hexahedral structure; and the reflecting plates are arranged on each of at least a pair of two of the metal walls facing each other.
